(19) United States
(12) Patent Application Publication
(10) Pub. No.: US 2022/0153072 A1
(43) Pub. Date: May 19, 2022

(54) Foot Control In A Vehicle Capable Of Flying In Air

(71) Applicant: PAL-V IP B.V., Rammsdonksveer (NL)

(72) Inventor: Sander de Roos, Raamsdonksveer (NL)

(21) Appl. No.: 17/439,723

(22) PCT Filed: Mar. 16, 2020
(86) PCT No.: PCT/NL2020/000006

§ 371 Date: Sep. 15, 2021

(30) Foreign Application Priority Data
Mar. 15, 2019 (NL) 1043194

(51) Int. Cl. B60F 5/02; B64C 37/00; B64D 31/04; B64C 13/04; B64C 13/30; B64C 13/40; B64C 25/42

(52) U.S. Cl. CPC B60F 5/02; B64C 37/00; B64D 31/04; B64C 25/42; B64C 13/30; B64C 13/40; B64C 13/044

(57) ABSTRACT

A hybrid fly/drive vehicle capable of being converted between a flying mode in which it is capable of flying in air and a road riding mode in which it is capable of driving on a road in normal traffic, includes an arrangement to allow the engine to be pedal-controlled in road riding mode and lever-controlled in flying mode, and further includes pedals for engine control and possibly clutch actuation in road riding mode and for rudder control in flying mode, which pedals also actuate the brakes in flying mode.

### FIELD OF THE INVENTION

The present invention relates in general to a vehicle capable of flying in air and capable of riding on a road such as to participate in road traffic as a normal car.

### BACKGROUND OF THE INVENTION

Typically, it is customary for flying machines such as airplanes, helicopters, gyrocopters to be either flying or standing on the ground, in a parking condition. Nevertheless, it is not uncommon for airplanes, helicopters, gyrocopters to have wheels, so that they can be displaced over ground. For mere displacement towards and from a parking location, they will normally be towed or pushed. For displacement towards and from a starting/landing location, they will normally propel themselves.

Notwithstanding the fact that helicopters and VTO jets can in principle take off from the position where they are standing, airplanes and gyrocopters do in fact need to gain sufficient horizontal speed for taking off. In special situations, such as gliders, that horizontal speed may be given by external towing apparatus or planes. Otherwise, those flying machines must propel themselves. This applies to take-off, but also to taxiing. For creating the required forward groundspeed, flying machines use their engines, via jet or propeller drive, which during flight provide the propulsion: at low power, the thrust is sufficient to get the machine rolling. However, this capability of self-powered rolling does not make those flying machines suitable for participating in road traffic like a normal car.

On the other hand, cars suitable for participating in road traffic must meet requirements regarding size, manoeuvrability, safety, etc. These requirements are not met by flying machines, and airplanes, helicopters and gyrocopters are not certified for use in traffic on public roads.

While flying machines are not equipped for road traffic, cars are not equipped for flying. Nevertheless, it is desirable to have a vehicle that can be converted from a flying condition to an automotive riding condition, and vice versa. Specifically, the present invention relates in general to a hybrid fly/drive vehicle, i.e. a vehicle that has a flying condition in which it is capable of and certified for flying in air, and that has a road riding condition in which it is capable of and certified for driving on a road in normal traffic. In the road riding condition, it should handle and behave much like a normal passenger car. Further, in order to be certified as an air vehicle, it should meet all air safety requirements in its flying condition, and in order to be certified as a car, it should meet all road safety requirements in its road riding condition.

The requirements which the vehicle must meet in the two different operating modes, physical as well as legal, are quite different and often even conflicting. It is a challenge to make the vehicle in such a manner that all requirements will be met and that changing the vehicle configuration from one mode to the other or vice versa can be done in an easy, safe and reliable manner.

### SUMMARY OF THE INVENTION

One of said requirements for road traffic relate to propulsion. It is generally not allowed that a road riding car is propelled by a rotary propeller. Thus, a hybrid fly/drive vehicle according to the present invention will have an engine that, in the road riding condition, drives at least one wheel. On the other hand, such driven wheel is not much use for propulsion while airborne, so that in the flying mode the vehicle will have an engine that drives an air propulsion device. Although it is possible to have separate engines dedicated for air propulsion and road propulsion, respectively, this approach requires much space for accommodating two engines, and adds substantially to the weight and costs of the vehicle. Thus, in a hybrid fly/drive vehicle according to the present invention, one and the same engine will be used for flying and driving, although an additional engine may be used for additional power in flying mode.

A particular aspect in this respect is the use of controls. A common feature of aircraft and cars is the presence of control pedals. However, the pedals have different functioning in aircraft and cars. An aircraft typically has two pedals, the primary function of which is rudder control. In aircraft of the type that have landing gear including wheels, those wheels may be provided with brakes that are also controllable by the pedals. Cars, on the other hand, have two or three pedals, for acceleration, braking, and (in the case of a manual gearbox) a third pedal for controlling the clutch.

In hybrid fly/drive vehicles according to prior art, two sets of pedals are used, one set for fly mode and one set for drive mode, leading to a total of 4 or 5 pedals. In one aspect of the present invention, at least one pedal is a combi pedal having dual functioning, i.e. a first function in fly mode and a second function in drive mode. Those functions may include rudder control in fly mode and accelerator control (also indicated as “throttle”) in drive mode.

It is customary for pedals to be connected by wires or cables. In a special aspect of the present invention, pedal control is hydraulic. This makes it easy to implement a switch for switching between fly mode functioning and drive mode functioning.

In flying machines, engine power control is typically performed by a swivelling lever that is pushed forward or pulled back. In motor cars, engine power control is typically performed by the right-hand pedal (accelerator). In hybrid fly/drive vehicles, the actuator (be it a lever in fly mode or a pedal in drive mode) must be coupled to a control input of the engine, which can be the same engine in flying mode as in drive mode.

For being allowed to be used in a hybrid fly/drive vehicle, the engine used must be an engine certified for flying machines. One of the safety requirements for an engine in a flying machine is that if control fails for any reason, i.e. if the control input of the engine is without control, the engine automatically goes to full throttle. To this end, the engine is equipped with a bias element, typically a spring, to bias the engine's control input to the MAX position. Said swivelling lever is connected to provide a counter-force, which is increased to reduce power.

On the other hand, engines for motor cars are equipped with a bias element, typically a spring, to bias the engine's control input to the MIN position, which in the case of an electric motor corresponds to ZERO and which in the case of a combustion engine corresponds to IDLE. Said pedal is connected to provide a counter-force, which is increased to increase power. If the driver takes his foot off the pedal, or if the accelerator cable connected to the accelerator pedal fails, motor power should automatically reduce to idle.

It is a challenge to combine these two functionalities in a hybrid fly/drive vehicle in a safe manner. Particularly, it is a challenge to provide a motor control system that comprises a usual throttle control lever for use in fly mode and a usual accelerator pedal for use in drive mode, taking into account that aviation conventions require that the entire path from throttle lever to engine is mechanically coupled without interruptions, and taking into account that it is not desirable to change anything in the design of the certified engine because then the certification is no longer valid.

In aircraft, rudder control is done by two coupled rudder pedals. Each pedal is displaced along a path substantially parallel to the longitudinal direction of the flying machine, with the two pedals moving in mutually opposite directions. The position of the pedals is associated with the deflection of the rudder. The further the pedals are displaced from a neutral position, the further the rudder is deflected, the more force the air flow will exert on the rudder, and the more yawing effect will be generated.

When taxiing on the ground, the speed is much lower than when airborne, hence the rudder will not produce a yawing effect, while further a nose wheel will have an effect of resistance against yawing. On the other hand, taxiing may involve the need for taking sharp turns, which does require transverse force beyond the capabilities of the rudder. To provide for this need, aircraft may be equipped with differential braking applied to the brakes of the main wheels. In some aircraft, these brakes can also be operated by pedals, for instance toe pedals, which are associated with the rudder pedals. Each toe pedal is associated with a corresponding one of the wheel brakes. Pressing a toe pedal will apply the corresponding brake; more pressing force will cause more braking force. Applying different force on the toe pedals will result in different braking at the left-hand wheel from the right-hand wheel, resulting in the plane making a turn toward the side with the highest braking force.

In this respect, a practical problem is in the natural response of the human. The pilot will start trying to yaw by rudder. Since the rudder action is insufficient, he will naturally respond by further depressing the rudder pedal trying to achieve more steering effect, until the rudder pedals reach their extreme position, which is a non-symmetric position as one rudder pedal will be positioned remote from the pilot while the opposite rudder pedal will be positioned close to the pilot. In this asymmetric position, the pilot must apply the toe brake of the most-depressed rudder pedal.

With a design like this, it is rather difficult or even impossible to brake while trying to drive straight. To avoid this problem, some aircraft are provided with separate brake controls.

In a hybrid fly/drive machine according to the present invention, when in flying mode, or in a flying machine according to the present invention, this problem is solved by a different interaction between rudder pedal and brake. As in prior art, the rudder pedals control the rudder. The pilot will start trying to yaw by rudder. Since the rudder action is insufficient, he will naturally respond by further depressing the rudder pedal trying to achieve more yawing effect, until the rudder pedals reach their extreme position. It is now a natural response by the pilot to try to obtain more yawing effect by increasing the foot pressure on the most-depressed rudder pedal. This increased pressure will be detected by a detection system, setting in operation a brake system on one side of the vehicle.

Said pressure will normally only occur at the end of the pedal travel, because, as long as the pedal has not yet reached the end of its travel, the rudder pedal will be displaced before pressure can be built up. Only at the end of its travel, when the rudder pedal can not be displaced any further, pressure can be increased sufficiently for the brake system to come into operation. However, according to a further aspect of the present invention, the pilot can exert counter pressure on the other rudder pedal. This normally has no effect for yawing, because rudder deflection is position-controlled rather than pressure-controlled. However, by exerting pressure on both rudder pedals, without necessarily changing the pedal positions, the brake system will come into operation with equal pressure for both wheels, allowing a braking action while continuing to drive straight.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIGS. 1A-1C schematically illustrate some aspects of an engine suitable and certified for use in flying machines;

FIG. 2 schematically illustrates the operation of a throttle lever in flying machines;

FIG. 3 schematically illustrates the operation of an acceleration pedal in a car;

FIG. 4 is a diagram schematically showing an exemplary throttle control system for a convertible fly/drive vehicle;

FIG. 5 is a diagram schematically illustrates a pedal control system suitable for use in a convertible fly/drive vehicle, in fly mode;

FIG. 6 is a diagram comparable to FIG. 5, illustrating the pedal control system in drive mode;

FIG. 7 is a diagram comparable to FIG. 5, illustrating the pedal control system for braking;

FIGS. 8A-C illustrate operation of a shuttle valve for use in the pedal control system for differential braking.

### DETAILED DESCRIPTION OF THE INVENTION

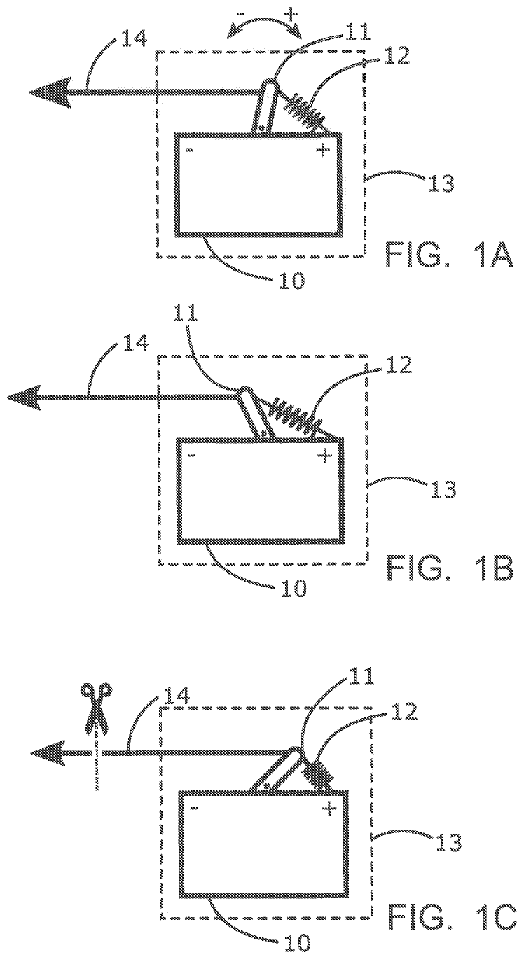

FIG. 1A schematically shows an engine 10 suitable and certified for use in flying machines. The engine 10 has a throttle input member 11, shown as a pivot lever, that has a position that can be varied between an extreme minimum (−) and an extreme maximum (+), corresponding to zero or low engine power and maximum engine power, respectively. A bias member 12, typically implemented as a pulling spring, is connected to the throttle input member 11 to exert a bias force biasing the throttle input member 11 towards the extreme maximum position.

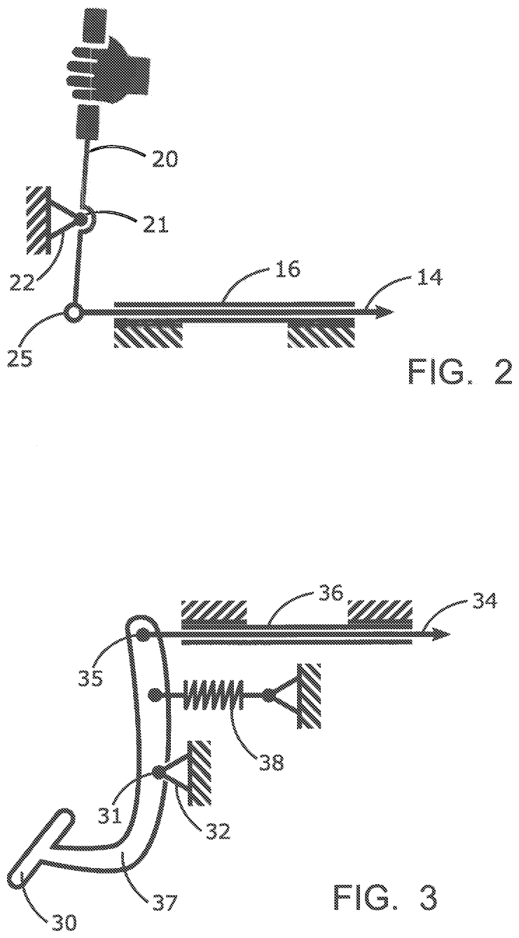

Users should not manipulate or amend the arrangement of the throttle input member 11 with the bias member 12, because then the certification would no longer be valid, and it would be necessary to go through a new certification process. Consequently, the combination of engine 10 with biased throttle input member 11, 12 can be considered as an integral unit, that will be indicated as engine assembly 13. A throttle control cable 14, connected to the throttle input member 11, constitutes the mechanical control input of the engine assembly 13. The control cable 14 is mechanically connected to a throttle control lever (see FIG. 2) that is to be handled by the pilot. Increasing a pulling force in the throttle control cable 14 will increasingly displace the throttle input member 11 against the bias force of bias member 12 to reduce power (FIG. 1B). Any failure in the form of an interruption of the connection between the throttle control lever and the throttle input member 11, in FIG. 1C shown as a broken throttle control cable 14, will eliminate said pulling force so that the bias member 12 will pull the throttle input member 11 to maximum. This is a safety feature, ensuring that power remains available during flight.

FIG. 2 schematically shows an example of the mechanical connection between a throttle control lever 20 and the throttle control cable 14, in a normal airplane. The throttle control lever 20 is pivotably mounted to the plane's chassis 22; the pivot is indicated as 21. An upper end of the throttle control lever 20 can be pushed (to the left in the figure) for increased power, or pulled (to the right in the figure) for reduced power. The cable 14 is connected, via link 25, to the lower end of the throttle control lever 20, opposite the pivot 21. It will be seen that pulling the throttle control lever 20 will result in increasing the pulling force in the throttle control cable 14.

It may be noted that the cable 14 may be, in whole or in part, implemented as a Bowden cable, as illustrated at 16.

It may be noted that the throttle control lever 20 may be provided with frictional clamping means (not shown) to keep the throttle control lever 20 in a position selected by the pilot without the pilot needing to actually continuously hold the lever.

FIG. 3 schematically illustrates the classical design of an accelerator pedal 30, comprising an arm 37 that is pivotably mounted to the car's chassis 32; the pivot is indicated as 31. Opposite the pivot 31, the arm 37 is connected to a gas cable 34 via a link 35, which gas cable may be, in whole or in part, implemented as a Bowden cable, as illustrated at 36. The pedal can be pressed down (to the right in the figure) for increased power, or released for reduced power, in which case a return spring 38 returns the pedal 30 to neutral position (to the left in the figure). If the cable 34 breaks, a bias spring at the car's engine will reduce the engine power to idle.

It will be clear that it is not simply possible to connect the accelerator pedal 30 to the aircraft engine assembly 13, because of conflicting requirements in the case of absence of user input.

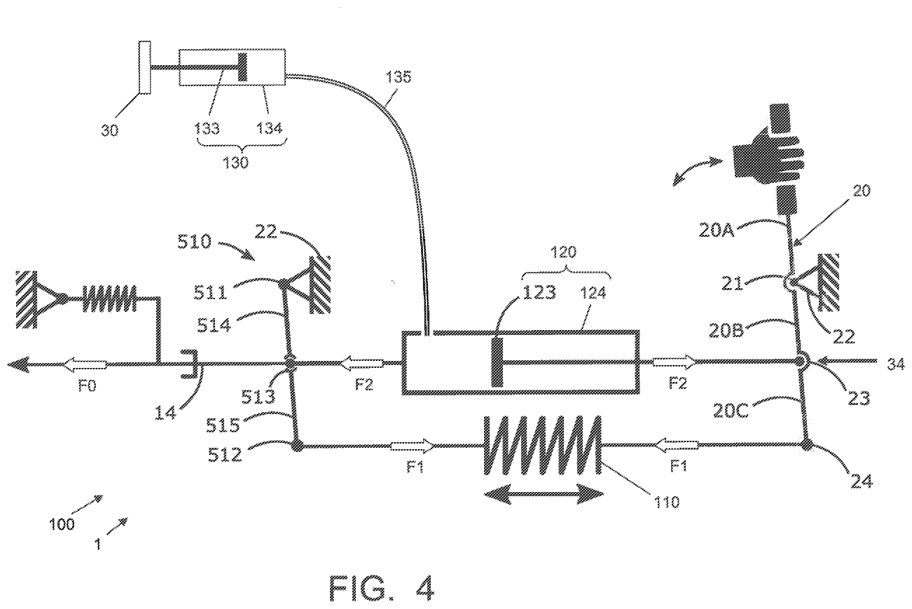

According to the present invention, this problem is solved by the following two features, illustrated schematically in FIG. 4:
1] Coupled between the throttle control lever 20 and the throttle control cable 14 is a master bias member 110, that effectively pulls the throttle control cable 14 towards the throttle control lever 20. The master bias member 110 exerts a master pulling force F1 on the throttle control cable 14, the master pulling force F1 being higher than the pulling force exerted by the engine's bias spring 12 (see FIG. 1A).
   Suitably, the master bias member 110 is a spring. This may be a pulling spring, connected directly to the throttle control cable 14, but it may also be a pushing spring, connected indirectly to the throttle control cable 14 via a force reversing pivoting lever.
2] Also coupled between the throttle control lever 20 and the throttle control cable 14 is a pedal-controlled actuator 120, exerting on the throttle control cable 14 an actuator force F2 counter-acting the master pulling force F1, and controlled by the accelerator pedal 30 such that increased pedal force corresponds to increased actuator force F2, and/or such that increased pedal depression corresponds to increased actuator displacement.
   Said actuator 120 may for instance be electrical or mechanical, but advantageously the actuator is hydraulic.
   Said actuator 120 may be connected directly parallel to the master bias member 110, but may also be connected indirectly parallel to the master bias member 110 via a force reversing pivoting lever.
      The operation is as follows:
A] In flying mode, the accelerator pedal 30 is without user input, hence no pedal force, hence no actuator force F2. The master bias member 110 pulls the throttle control lever 20 and the throttle control cable 14 towards each other until the master bias member 110 reaches an extreme position, defined for instance by actuator 120 or by a separate stop. From that moment on, the master bias member 110 behaves as a fixed connection between the throttle control lever 20 and the throttle control cable 14, as is required by aviation regulations, so that the throttle control cable 14 always follows the movements by the throttle control lever 20. When there is a failure in the path from throttle control lever 20 to throttle control cable 14, so that this path is interrupted, the engine bias member 12 pulls the throttle input member 11 of engine 10 to full throttle, as is required by aviation regulations.
B] In drive mode, the throttle control lever 20 is without user input and maintains a fixed reference position, as ensured by for instance a friction coupling to the chassis. When the driver does not touch the accelerator pedal 30, the situation is as above: the accelerator pedal 30 is in an idle position, and the actual engine power is determined by the actual position of the throttle control lever 20; this may be termed “idle” power. When the user depresses the accelerator pedal 30, the pulling force on the throttle control cable 14 (being the result of F1 minus F2) is reduced, giving way to the engine bias member 12 to pull the engine's throttle input member 11 to higher power.

Although the above can, as desired, be implemented by mechanical or electrical means, a preferred embodiment is based on hydraulic implementation, as also illustrated in FIG. 4.

FIG. 4 is a diagram schematically showing an exemplary throttle control system 100 as part of a vehicle 1. Reference numeral 110 indicates the master bias member, shown here implemented as a spring, arranged between the throttle control lever 20 and the throttle control cable 14, exerting a master pulling force F1 on the throttle control cable 14, which acts against the pulling force F0 exerted by the engine's bias spring 12. The pedal-controlled actuator 120 is shown here as a controlled hydraulic piston/cylinder assembly 120, connected directly parallel to the master bias spring 110, and comprising a piston 123 in a cylinder 124.

Reference numeral 130 indicates a control hydraulic piston/cylinder assembly 130, comprising a piston 133 in a cylinder 134, associated with a foot pedal 30 (compare FIG. 3) and coupled to the controlled hydraulic piston/cylinder assembly 120 via a hydraulic line 135, in such a way that depressing the pedal 30 results in extension of the pedal-controlled actuator 120.

FIG. 4 also illustrates the advantageous use of an auxiliary control lever 510. The throttle control lever 20 comprises three lever segments 20A, 20B, 20C, respectively between the free control end and pivot 21, between the pivot 21 and the joint 23 where the pedal-controlled actuator 120 engages, and between said joint 23 and the joint 24 where the master bias member 110 engages. The auxiliary control lever 510 has a free end 511 pivotably attached to the frame 22, has an opposite end joint 512 pivotably connected to the master bias member 110, and has an intermediate joint 513 where the throttle cable 14 is connected, and where the pedal-controlled actuator 120 engages. The length of a first lever segment 514 between free end 511 and intermediate joint 513 is the same as the length of throttle control lever segment 20B. The length of a second lever segment 515 between intermediate joint 513 and opposite end joint 512 is the same as the length of throttle control lever segment 20C. The distance between intermediate joint 513 and said joint 23 of the throttle control lever 20 is the same as the length of the master bias member 110 in its rest condition. Thus, the auxiliary control lever 510 mirrors the movements of the throttle control lever 20 when in flying mode. When in riding mode, the auxiliary control lever 510 behaves as a reverse-acting throttle control lever, controlled by the accelerator pedal 30.

It Is to be noted that hydraulic control is preferred, but the principles of this invention can also be implemented by electrical or mechanical embodiments. For instance, cable 34 of FIG. 3 can be connected to the nodes 513/23 to replace the hydraulic piston.

In the embodiment of FIG. 4, the arrangement of the hydraulic piston/cylinder assemblies 120, 130 with hydraulic line 135 in between can be indicated as a ‘pushing’ actuation of the pedal 30. Alternative embodiments are possible where depressing the pedal 30 result in a ‘pulling’ actuation, for instance cable 34 of FIG. 3 as already mentioned.

While the throttle control cable 14 requires to be actuated by a pulling force, that can be seen as a negative actuation since it counteracts bias member 12 so that increased pulling force results in reduced engine power, and while the mechanism proposed by the present invention exerts on the throttle control cable 14 a master bias pulling force which is reduced by increased pedal action, it is not essential that the master bias member 110 itself is a pulling member; in an alternative embodiment, the master bias member 110 may exert pushing force.

In the embodiment of FIG. 4, the master bias member 110 and the pedal-controlled actuator 120 are arranged directly parallel, so that a bias pulling force by the master bias member 110 is to be counteracted by an operational pushing force exerted by the pedal-controlled actuator 120. It is however also possible to connect the master bias member 110 and the pedal-controlled actuator 120 opposite ends of a hinge structure, so that a bias pulling force by the master bias member 110 is to be counteracted by an operational pulling force exerted by the pedal-controlled actuator 120.

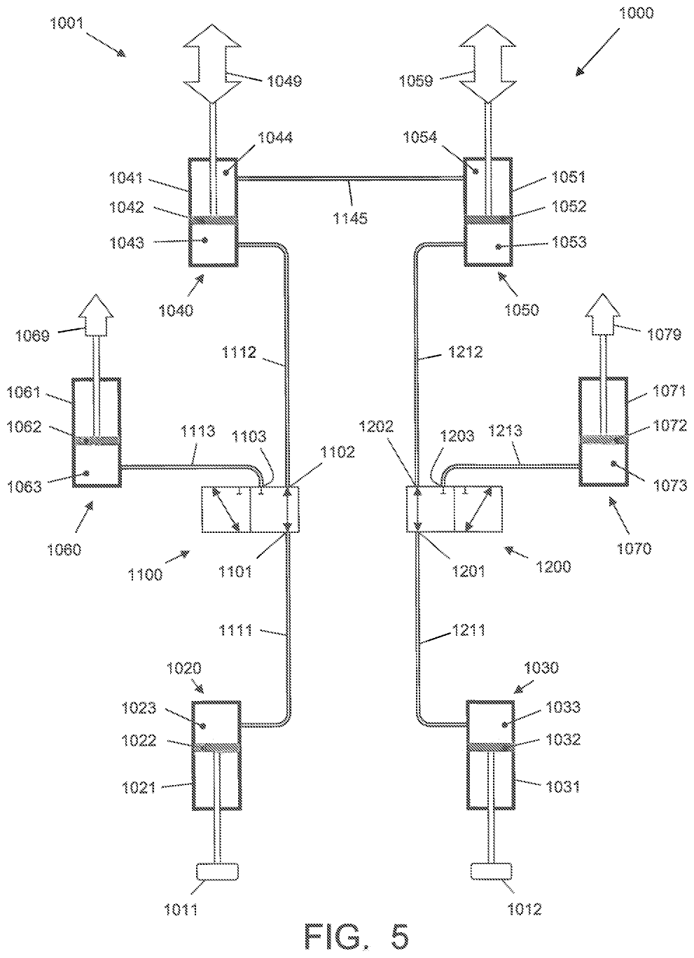

FIG. 5 schematically illustrates a pedal control system 1000 for use in a convertible fly/drive vehicle, generally indicated at 1001. The control system 1000 comprises two foot pedals schematically indicated at 1011 and 1012.

The control system 1000 further comprises two hydraulic control units 1020, 1030. Each hydraulic control unit is shown here implemented as a combination of a cylinder 1021, 1031 and a piston 1022, 1032. Here and in the following, it will always be assumed that cylinders are stationary and that pistons are displaceable within the respective cylinders, but the opposite will also be possible.

Between the piston 1022, 1032 and the respective cylinder 1021, 1031, a respective control chamber 1023, 1033 is defined, having a volume depending on the position of the piston within the cylinder. The lefthand pedal 1011 is coupled to a first one 1022 of said pistons, while the righthand pedal 1012 is coupled to a second one 1032 of said pistons.

Reference numerals 1040 and 1050 indicate lefthand and righthand rudder actuators, respectively. Each rudder actuator comprises a respective cylinder 1041, 1051, piston 1042, 1052, and actuator chamber 1043, 1053. Opposite the actuator chamber 1043, 1053, each rudder actuator 1040, 1050 comprises a balance chamber 1044, 1054 defined between the piston 1042, 1052 and the respective cylinder 1041, 1051. Each rudder actuator 1040, 1050 is coupled to a respective rudder of the vehicle 1001, as schematically indicated by arrows 1049, 1059.

It is noted that each rudder actuator 1040, 1050 may be capable of exerting pushing action as well as pulling action.

It is further noted that this embodiment is suited for a vehicle having two rudders. If only one rudder is present, one rudder actuator may be omitted, and/or a through rod actuator may be used. If three or more rudders are present, three or more rudder actuators may be connected in series in the hydraulic loop between 1112 and 1212. It is also possible to have two rudder actuators connected to a single rudder, to obtain redundancy.

Reference numerals 1100 and 1200 illustrate respective hydraulic valves. Each hydraulic valve has a first input port 1101, 1201 and a first output port 1102, 1202.

A first and a second hydraulic line 1111, 1211 connect the respective control chambers 1023, 1033 with the respective first input ports 1101, 1201 of the respective hydraulic valves 1100, 1200.

A third and a fourth hydraulic line 1112, 1212 connect the respective rudder actuator chambers 1043, 1053 with the respective first output ports 1102, 1202 of the respective hydraulic valves 1100, 1200.

A fifth hydraulic line 1145 connects the balance chambers 1044, 1054 to each other.

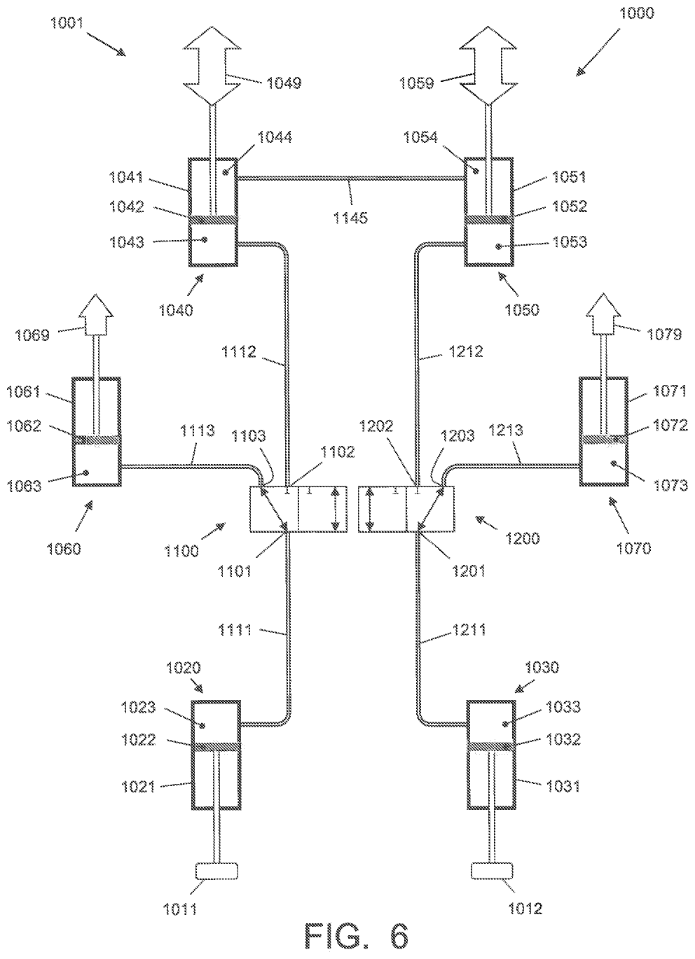

The hydraulic valves 1100, 1200 each have a fly mode position and a drive mode position. FIG. 5 shows the hydraulic valves 1100, 1200 in their fly mode position, while FIG. 6 is a diagram comparable to FIG. 5 showing the hydraulic valves 1100, 1200 in their drive mode position.

In the fly mode position of the hydraulic valves 1100, 1200, the respective first input ports 1101, 1201 are internally connected to the respective first output ports 1102, 1202. It will be understood that the first control chamber 1023 forms a closed hydraulic coupling with the first actuator chamber 1043 via lines 1111 and 1112, and that the second control chamber 1033 forms a closed hydraulic coupling with the second actuator chamber 1053 via lines 1211 and 1212. It will further be understood that the balance chambers 1044, 1054 form a closed hydraulic coupling via line 1145.

It will further be understood that a closed hydraulic loop is defined between the two pedals 1011 and 1021. Depressing the righthand pedal 1012 will force hydraulic fluid to flow from the second control chamber 1033 to the second rudder actuator chamber 1053, resulting in a rudder actuation 1059 in one direction, while at the same time hydraulic fluid will be forced from the second rudder balance chamber 1054 to the first rudder balance chamber 1044, resulting in a rudder actuation 1049 in opposite direction in a balanced manner. Also at the same time hydraulic fluid will be forced from the first rudder actuator chamber 1043 to the first control chamber 1023, causing the lefthand pedal 1011 to be displaced towards the driver. Likewise, depressing the lefthand pedal 1011 will cause opposite rudder action and displacement of the righthand pedal 1012 towards the driver.

It is noted that the hydraulic valves 1100, 1200 may be mutually independent valves, requiring the vehicle driver to set both valves in their required positions. It is however preferred that the hydraulic valves 1100, 1200 are coupled valves, so that they are always set simultaneously, which avoids possible driver errors. It is even more preferred that the two valves are actually two parts of one integral valve unit.

It is noted that the control system 1000 is a passive hydraulic system. No pressure multiplier is used. As a consequence, any displacement of one pedal results in an equal displacement of the other pedal in opposite direction, with simultaneous rudder “positive” rudder displacement. The driver will receive good feedback from the system, the driver feels what the rudder is doing.

It is preferred that the control units 1020, 1030 are mutually identical, and that the actuator units 1040, 1050 are mutually identical. It may be useful if the control units 1020, 1030 have the same design as the actuator units 1040, 1050, to reduce the number of different components. On the other hand, it may be useful if the control units 1020, 1030 differ from the actuator units 1040, 1050, to obtain a desirable stroke ratio.

Apart from the components described so far, relevant for the fly mode, pedal control system 1000 comprises components relevant for the drive mode, which will be discussed in the following with reference to FIG. 6. Here, reference numerals 1060 and 1070 indicate a clutch actuator and a throttle actuator, respectively. The clutch actuator 1060 comprises a cylinder 1061, piston 1062, and clutch actuator chamber 1063, and is coupled to a clutch mechanism, schematically indicated by arrow 1069. The throttle actuator 1070 comprises a cylinder 1071, piston 1072, and throttle actuator chamber 1073, and is coupled to a throttle mechanism, schematically indicated by arrow 1079.

Each hydraulic valve has a second output port 1103, 1203. A sixth and a seventh hydraulic line 1113, 1213 connect the respective clutch and throttle actuator chambers 1063, 1073 with the respective second output ports 1103, 1203 of the respective hydraulic valves 1100, 1200.

In the drive mode position of the hydraulic valves 1100, 1200, as shown in FIG. 6, the respective first input ports 1101, 1201 are internally connected to the respective second output ports 1103, 1203. It will be understood that the first control chamber 1023 forms a closed hydraulic coupling with the clutch actuator chamber 1063 via lines 1111 and 1113, and that the second control chamber 1033 forms a closed hydraulic coupling with the throttle actuator chamber 1073 via lines 1211 and 1213.

It will further be understood that, in contrast to the fly mode in which the two pedals 1011 and 1021 are hydraulically coupled to move in opposite directions, in drive mode the two pedals 1011 and 1021 operate completely independent from each other.

It is noted that, with the valves 1100, 1200 in their drive mode position, hydraulic lines 1112 and 1212 are effectively closed at the respective ports 1102, 1202 of the valves 1100, 1200. Consequently, no hydraulic fluid can flow into or out of the first and second rudder actuator chambers 1043, 1053, i.e. the respective pistons 1042, 1052 can not be displaced, i.e. the rudder is blocked. This is a desirable property of the rudder control mechanism, because it avoids the need of having a separate latch for blocking the rudder and it avoids the need of an additional user action to set the latch in blocking position, and vice versa when making a transition from drive mode to fly mode.

Making a transition from drive mode to fly mode or vice versa involves driver actions, including a driver action to switch the hydraulic valves 1100, 1200 to the relevant position. In order to prevent that the hydraulic valves 1100, 1200 are inadvertently switched over while driving or while flying, an advanced safety mechanism may be installed. However, in a simple yet practical embodiment, the hydraulic valves 1100, 1200 are mounted at a position that can not be reached from within the passenger cabin, for instance in the baggage compartment, so that such safety mechanism is superfluous.

The above-described embodiment relates to a vehicle with manual gear shift and corresponding pedal-controlled clutch mechanism. In the case of an automatic gear shift mechanism, the clutch actuator 1060 and some associated components may of course be omitted.

With reference to FIG. 4, throttle control has been described and explained to comprise a pedal-controlled actuator 120 connected in parallel to a master bias member 110. Said pedal-controlled actuator 120 can be the throttle actuator 1070 in FIGS. 5 and 6.

In summary, with this invention it is thus possible to use 2 pedals for 4 functions, namely:

1) rudder right in fly mode
2) rudder left in fly mode
3) throttle in drive mode (accelerator)
4) clutch in drive mode (in case of manual gear shift).

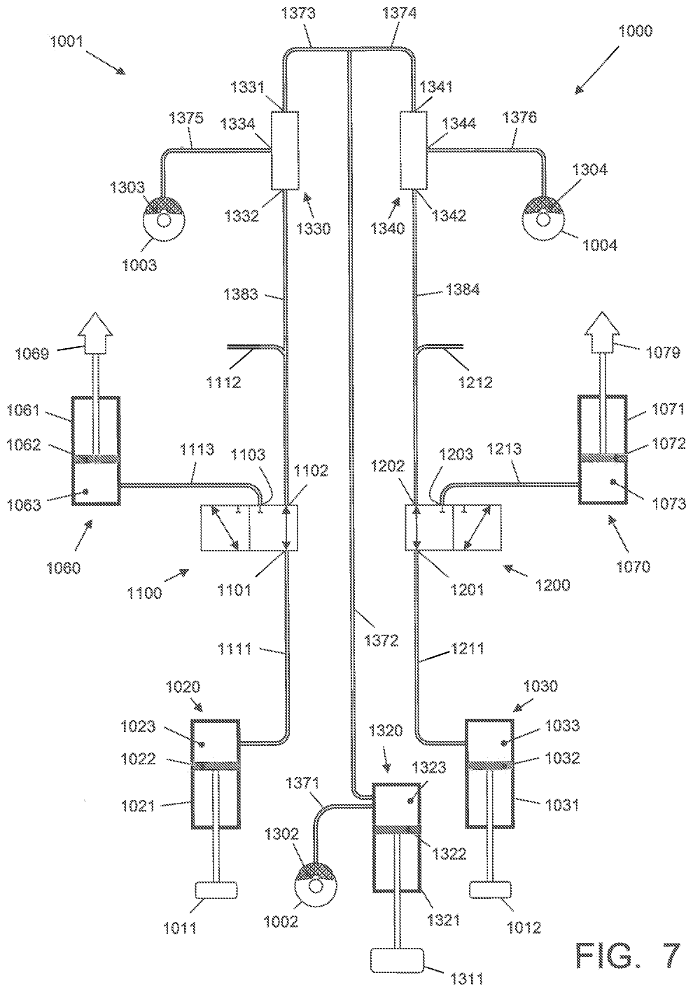

A further elaboration of the invention relates to braking, and will be discussed with reference to FIG. 7, which is a diagram comparable to FIG. 5. Apart from the pedals 1011 and 1012 already discussed, the pedal control system 1000 further comprises a brake pedal schematically indicated at 1311 and an associated third hydraulic control unit 1320, shown here implemented as a combination of a cylinder 1321 and a piston 1322 with a brake control chamber 1323.

Reference numeral 1002 indicates a central wheel, which in the case of a hybrid fly/drive vehicle will typically be a front wheel/nose wheel but which also may be a rear wheel/tail wheel. This wheel may also be a single unit consisting of two wheels mounted together, i.e. a double wheel. A first brake line 1371 couples the brake control chamber 1323 to the brake system (calliper) 1302 of the central wheel 1002.

Reference numerals 1003 and 1004 respectively indicate a lefthand wheel (or wheel unit) and a righthand wheel (or wheel unit), with respective brake systems (callipers) 1303 and 1304. The brake pedal 1311 also controls the brake action of these side wheels 1003, 1004. This may be done via the same brake control chamber 1323 of the same third hydraulic control unit 1320, as shown, but may also be done via a different hydraulic control unit, which is however not illustrated for sake of simplicity. In the embodiment shown, the brake control chamber 1323 is coupled to a common brake line 1372 for the side wheels 1003, 1004, which later branches into two main brake lines 1373 and 1374 for the lefthand wheel 1003 and the righthand wheel 1004, respectively. Alternatively, it is possible that the two main brake lines 1373 and 1374 connect individually to the third hydraulic control unit 1320, perhaps even to separate control chambers of this control unit, without a common brake line portion.

The two main brake lines 1373 and 1374 communicate, via secondary brake lines 1375 and 1376, respectively, to the side wheel brake systems 1303, 1304, respectively. Ignoring for a moment the other components of the brake system, it will be clear that actuating third pedal 1311 will result in a braking action at each of said wheels 1002, 1003, 1004.

It is noted that the brake circuit is provided with a reservoir for brake fluid, but this is not shown for sake of simplicity.

It is noted that an embodiment is possible where brakes are only present at the side wheels 1003, 1004, omitting any brake at the central wheel 1002.

It is further noted that the brake system may be arranged such that braking power is distributed between central and side wheels in a predetermined ratio.

In the drive mode (see FIG. 6), the brakes 1302, 1303, 1304 are only actuated through the third pedal 1311 (not shown in FIG. 6). In fly mode, the system also provides for actuation of the side brakes 1303, 1304 through the rudder control pedals 1011, 1012. To that end, the respective first output ports 1102, 1202 of the hydraulic valves 1100, 1200 connect to hydraulic brake control lines 1383, 1384. These may connect directly to said output ports 1102, 1202, or branch off from common line portions in common with the third and fourth hydraulic rudder control lines 1112, 1212, respectively, as shown. In any case, the design is such that the brake control action in brake control lines 1383, 1384 is in parallel to the rudder control action in rudder control lines 1112, 1212, respectively, with the proviso that, if needed and desired, provision may be made to have the pressure in lines 1112, 1212 differ from the pressure in lines 1383, 1384, respectively. In the branched embodiment shown, the pressure in said lines will always be the same.

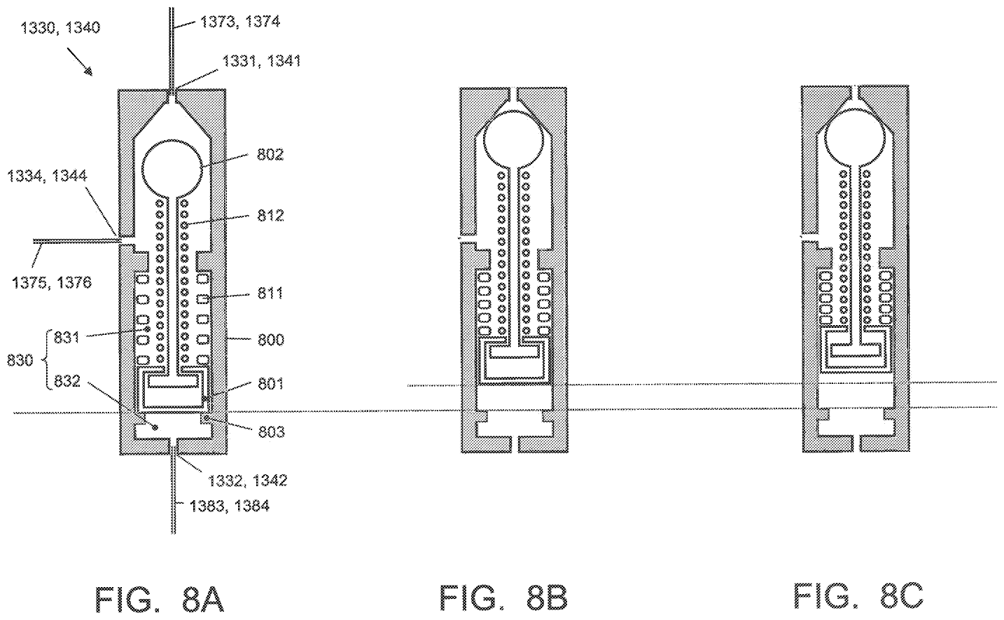

The system further comprises a first separation/shuttle assembly 1330 for the lefthand brake 1303 and a second separation/shuttle assembly 1340 for the righthand brake 1304. The design of these separation/shuttle assemblies 1330, 1340 will be described in more detail with reference to FIGS. 8A-C.

Each separation/shuttle assembly 1330, 1340 comprises a valve housing 800 with an interior chamber 830. A piston 801 is mounted sealingly within the chamber 830, sealingly dividing the chamber 830 in a primary chamber 831 and a secondary chamber 832.

Each separation/shuttle assembly 1330, 1340 has a first input port 1331, 1341 communicating to the primary chamber 831, an output port 1334, 1344 communicating to the primary chamber 831, and a second input port 1332, 1342 communicating to the secondary chamber 832.

Each separation/shuttle assembly 1330, 1340 further comprises a valve member 802 for closing the first input port 1331, 1341, coupled to the piston 801 to control the position of the valve member 802. A first bias member 811 is arranged to exert on the piston 801 a first bias force with respect to the housing 800, urging the piston 801 towards reducing the volume of the secondary chamber 832, causing the piston 801 to lift the valve member 802 to open the first input port 1331, 1341. A second bias member 812 is arranged to exert on the valve member 802 a second bias force with respect to the piston 801, urging the valve member 802 towards closing the first input port 1331, 1341.

The first input port 1331, 1341 is connected to a main brake line 1373, 1374, respectively.

The second input port 1332, 1342 is connected to a brake control line 1383, 1384, respectively.

The output port 1334, 1344 is connected to a secondary brake line 1375, 1376, respectively.

Operation of this valve design is as follows.

In a first operative condition, shown in FIG. 8A, the pressure at the second input port 1332, 1342 is relatively low. The first bias member 811 has displaced the piston 801 towards the second input port 1332, 1342 and presses the piston 801 against a stop 803. In turn, the piston 801 engages the valve member 802 to lift this valve member from the first input port 1331, 1341 so that the first input port 1331, 1341 is open. There is now an open connection between the first input port 1331, 1341 and the output port 1334, 1344 for exchanging fluid. The pressure at the output port 1334, 1344 is equal to the pressure at the first input port 1331, 1341.

The bias force of the first bias member 811 is substantially larger than the force exerted by the pressure at the second input port 1332, 1342. When the pressure at the second input port 1332, 1342 rises, the piston 801 remains stationary, until the pressure at the second input port 1332, 1342 reaches a first threshold value where the force exerted on the piston 801 by the pressure at the second input port 1332, 1342 balances the bias force of the first bias member 811. As long as the pressure at the second input port 1332, 1342 remains below said first threshold value, pressure variations at the second input port 1332, 1342 will have no effect on the pressure at the output port 1334, 1344, and the first input port 1331, 1341 will remain open.

When the pressure at the second input port 1332, 1342 reaches said first threshold value, the piston 801 is displaced against the bias force of the first bias member 811, and consequentially the valve member 802 is displaced towards the first input port 1331, 1341.

When the pressure at the second input port 1332, 1342 reaches a second threshold value, the valve member 802 reaches the first input port 1331, 1341 and closes the first input port 1331, 1341, as shown in FIG. 8B. This second threshold value is, among other things, determined by a combination of the stiffness of the first bias member 811 and the stroke the valve member 802 has to make before it reaches the first input port 1331, 1341. This stroke is shown exaggerated in the figures, and said second threshold value may be practically equal to said first threshold value.

In a second operative condition, shown in FIG. 8C, the pressure at the second input port 1332, 1342 is relatively high, i.e. higher than said first threshold value. An increase of the pressure at the second input port 1332, 1342 will displace the piston 801 further against the bias force of the first bias member 811 to increase the volume of the secondary chamber 832, while the valve member 802 remains stationary, keeping the first input port 1331, 1341 closed with increasing bias force from the second bias member 811. The displacing piston 801 will increase the pressure in the primary chamber 831, which will help to keep the valve member 802 closing the first input port 1331, 1341, and which pressure can not pass the first input port 1331, 1341.

It is noted that the same functionality can be achieved with different components, but the proposed shuttle valve design has the advantage of integrated design in one unit.

It is noted that the piston 801 functions as a separation piston to keep the brake fluid in the first chamber 831 separated from the hydraulic control fluid in lines 1383, 1384.

Operation of the brake system is as follows.

In drive mode, lefthand pedal 1011 and righthand pedal 1012 do not connect to the brake circuit, only the central pedal 1311 is active to apply brake action, as is normal to a car. This central pedal 1311 may also be termed the brake pedal, and in fact the third hydraulic control unit 1320 may be a conventional brake cylinder with associated conventional brake fluid reservoir. Applying pressure to the central brake pedal 1311 will force fluid through the common brake line 1372, the two main brake lines 1373, 1374 and the two secondary brake lines 1375, 1376 to the side wheel brake systems 1303, 1304, respectively. Brake force will be generated at the side wheels 1003, 1004 in a symmetric way, i.e. no deviation from straight line travel will be caused by the braking action. Steering action (deviating from straight line travel) must be effected by handling the orientation of the central wheel 1002 through the steering wheel (not shown).

While for instance taxiing in fly mode, the action of the central brake pedal 1311 remains the same. But in fly mode, the driver will probably have his feet positioned at the rudder pedals 1011, 1012, and may try to achieve steering by rudder action (yaw control). At relative low pressure in lines 1383, 1384, the shuttle valves 1330, 1340 are in the condition of FIG. 8A. The pressure exerted by the rudder pedals 1011, 1012 can be varied, resulting in rudder variation, and without resulting in any braking action as long as said pressure remains lower than said first threshold pressure.

When the driver for instance depresses the righthand rudder pedal 1012, the rudder will deflect as described before, which will result in some transverse force, but insufficient for obtaining the required turning of the vehicle. Finding that the vehicle does not respond by changing direction as required, the natural response by the driver will be to depress the righthand rudder pedal 1012 still further, up to a point where the pressure in the line 1384 reaches said threshold value. This may typically be after the rudder mechanism has reached a stop and the driver presses the righthand rudder pedal 1012 even harder, but the threshold pressure may be achieved earlier. In any case, beyond this threshold pressure, the righthand valve 1340 will be in its second operative condition (FIG. 8C) and the righthand rudder pedal 1012 will actuate the righthand brake 1304. Since the piston 802 closes the first input port 1341, the pressure from the righthand rudder pedal 1012 can not reach the opposite brake, so that only the righthand brake 1304 is actuated. This causes the vehicle to turn to the right, as required.

A similar response in opposite direction will of course result if the driver presses the lefthand rudder pedal 1011.

If it is intended to reduce speed, the driver may use the central brake pedal 1311, as described above. This is, after all, a brake pedal. But, when in fly mode, the driver will physically be in a fly position with his feet on the rudder pedals, and he will probably be in a fly state of mind, and his normal response may be that he presses both pedals. This will be even more so if he needs to respond in an emergency situation. In the system of the invention, the driver can use any pedal, or any combination of pedals, to achieve a braking effect.

Irrespective of the position of the rudder and irrespective of the respective positions of the rudder pedals 1011, 1012, if the driver increases pressure on both pedals, eventually said threshold pressure would be reached in both shuttle valves 1330, 1340 at the same time, so that both brakes would be actuated at the same time and at the same brake pressure, because the rudder pedals/cylinders are linked.

Summarizing, rudder control as well as braking is possible with pedals without being equipped with toe pedals.

It is further noted that, although the above has been explained for a hydraulic implementation, the function of using a pedal for rudder control at low pedal force or pressure and for brake control at high pedal force or pressure can also be implemented mechanically or even electrically.

Summarizing, the present invention provides a hybrid fly/drive vehicle capable of being converted between a flying mode in which it is capable of flying in air and a road riding mode in which it is capable of driving on a road in normal traffic. The vehicle comprises an arrangement to allow the engine to be pedal-controlled in road riding mode and lever-controlled in flying mode, and comprises pedals for engine control and possibly clutch actuation in road riding mode and for rudder control in flying mode, which pedals also actuate the brakes in flying mode.

Nevertheless, some aspects of the present invention are also useful in vehicles that are capable of and certified for flying in air without having a road riding mode. For instance, the fact that rudder control as well as braking is possible with pedals without being equipped with toe pedals is not only useful for a convertible fly/drive vehicle but also for a ‘normal’ aircraft. This can in general be achieved by use of a force sensor that applies a brake above a force threshold.

It is noted that the word “engine” as used in this description and in the claims is intended to refer to a suitable power source in the broadest sense, and not to limit the type of power source in any way. By way of non-limiting example, it may for instance include an (internal) combustion engine, but it may also include an electric motor. Likewise, while the phrase “throttle” is used for sake of convenience since this is familiar in aircraft context, it is intended to refer to any control of the power source in the broadest sense, including control of an electric motor.

It should be clear to a person skilled in the art that the present invention is not limited to the exemplary embodiments discussed above, but that several variations and modifications are possible within the protective scope of the invention as defined in the appending claims. For instance, some of the hydraulic communication lines may be replaced by mechanical connections, such as rods or cables, but this would entail drawbacks. It will be difficult or even impossible to connect in straight lines between pedals and controls, as would be required for pushing actions. Bowden cables can take corners, but this will cause increased friction and/or they are subject to elastic extension, reducing accuracy. Further, the increased weight is problematic.

Even if certain features are recited in different dependent claims, the present invention also relates to an embodiment comprising these features in common.

Even if certain features have been described in combination with each other, the present invention also relates to an embodiment in which one or more of these features are omitted. For instance, using hydraulics in a combined rudder control/braking control system in the manner described, so that increased pedal pressure at the end of pedal travel will result in applying the brakes, is also useful in a flying machine that is not a hybrid fly/drive vehicle. In such embodiment, referring to FIGS. 6A, 6B and 7, the valves 1100, 1200 and the actuators 1060, 1070 could be omitted. Further, the third pedal 1311 with associated control actuator 1320 could be omitted, and the same applies to lines 1372, 1373, 1374. In the biased valves 1330, 1340, the valve member 802 and the second bias member 812 could be omitted. The first input 1331, 1341 could be omitted, i.e. closed, or could be connected to a brake fluid reservoir, possibly a common reservoir.

Features which have not been explicitly described as being essential may also be omitted.

Any reference signs in a claim should not be construed as limiting the scope of that claim.

1. A hybrid fly/drive vehicle, capable of being converted between a flying mode in which it is capable of flying in air and a road riding mode in which it is capable of driving on a road, the vehicle comprising:
a body with a passenger cabin, a set of wheels for riding on road, lifting means for providing lift for flying in air, and propelling means for propelling the vehicle while airborne;
an engine assembly, comprising an engine provided with a throttle bias member connected to the throttle input member and effective to exert on the throttle input member a throttle bias force to bias the engine towards full throttle, the engine assembly further comprising a throttle control member connected to the throttle input member and arranged to exert on the throttle input member a variable throttle control force opposite to throttle bias force in order to control engine power;
wherein, in the flying mode, the engine is connected to drive the propelling means;
wherein, in the road riding mode, the engine is connected to drive at least one of the wheels;
wherein the vehicle further comprises:
a first user-controlled engine power control arrangement for controlling engine power in the flying mode; and
a second user-controlled engine power control arrangement for controlling engine power in the road riding mode;
wherein the first user-controlled engine power control arrangement comprises a throttle control lever continuously coupled to the throttle control member; and
wherein the second user-controlled engine power control arrangement comprises a pedal-controlled actuator coupled between the throttle control lever and the throttle control member, and an accelerator pedal for controlling the pedal-controlled actuator.

2. The hybrid fly/drive vehicle according to claim 1, wherein the throttle control lever is arranged for applying on the throttle control member the throttle control force that is increased to reduce engine power, and wherein the pedal-controlled actuator is arranged such that increased depression of the accelerator pedal reduces the throttle control force.

3. The hybrid fly/drive vehicle according to claim 1, wherein the throttle control member is a cable and the throttle control force is a pulling force.

4. The hybrid fly/drive vehicle according to claim 1 further comprising:
a master bias member coupled between the throttle control lever and the throttle control cable, exerting on the throttle control cable a master pulling force larger than the throttle bias force; and
the pedal-controlled actuator being arranged to generate a counter acting force to counteract the master bias member;
wherein the actuator is arranged such that increased pedal force corresponds to increased counter-acting actuator force, and/or such that increased pedal depression corresponds to increased actuator displacement.

5. The hybrid fly/drive vehicle according to claim 4, wherein the pedal-controlled actuator is connected directly parallel to the master bias member.

6. The hybrid fly/drive vehicle according to claim 4, wherein the pedal-controlled actuator is connected indirectly parallel to the master bias member via a force reversing pivoting lever.

7. The hybrid fly/drive vehicle according to claim 1, wherein the pedal-controlled actuator is a hydraulic actuator.

8. A hybrid fly/drive vehicle, capable of being converted between a flying mode in which it is capable of flying in air and a road riding mode in which it is capable of driving on a road in normal traffic, the vehicle comprising:
a first actuator operative in the flying mode to actuate a first flying mode function;
a second actuator operative in the road riding mode to actuate a first road riding mode function;
a dual function human interface control member for selectively controlling the operation of the first actuator or the second actuator; and
a selection switch having a flying mode position and a road riding mode position, associated with the first actuator, the second actuator and the human interface control member, wherein the selection switch is configured:
in its flying mode position, to couple the human interface control member to the first actuator; and
in its road riding mode position, to couple the human interface control member to the second actuator.

9. The hybrid fly/drive vehicle according to claim 8, wherein the human interface control member comprises a foot pedal.

10. The hybrid fly/drive vehicle according to claim 8, wherein the first actuator comprises a rudder displacement actuator.

11. The hybrid fly/drive vehicle according to claim 8, wherein the second actuator comprises an accelerator actuator.

12. The hybrid fly/drive vehicle according to claim 8, wherein the human interface control member is provided with a hydraulic control unit;
wherein the first actuator is a hydraulic actuator;
wherein the second actuator is a hydraulic actuator;
wherein the selection switch is a hydraulic switch comprising an input port, a first output port and a second output port;
wherein the hydraulic control unit is coupled to the input port by a hydraulic line;
wherein the first actuator is coupled to the first output port by a hydraulic line;
wherein the second actuator is coupled to the second output port by a hydraulic line;
wherein the selection switch in its flying mode position connects the input port to the first output port; and
wherein the selection switch in its road riding mode position connects the input port to the second output port.

13. The hybrid fly/drive vehicle according to claim 8 further comprising:
a third actuator operative in the flying mode to actuate a second flying mode function;
an optional fourth actuator operative in the road riding mode to actuate an optional second road riding mode function;
a second human interface control member for controlling the operation of the third actuator or the optional fourth actuator; and
a second selection switch having a flying mode position and a road riding mode position, associated with the third actuator, the optional fourth actuator and the second human interface control member, wherein the second selection switch is configured:
in its flying mode position, to couple the second human interface control member to the third actuator; and
in its road riding mode position, to couple the second human interface control member to the optional fourth actuator.

14. The hybrid fly/drive vehicle according to claim 13, wherein the second human interface control member comprises a foot pedal;
wherein the third actuator comprises a rudder displacement actuator; and
wherein the optional fourth actuator comprises an optional clutch actuator.

15. The hybrid fly/drive vehicle according to claim 13, wherein the second human interface control member is provided with a second hydraulic control unit;
wherein the third actuator is a hydraulic actuator;
wherein the optional fourth actuator is a hydraulic actuator;
wherein second selection switch is a hydraulic switch comprising an input port, a first output port and a second output port;
wherein the second hydraulic control unit is coupled to the input port by a hydraulic line;
wherein the third actuator is coupled to the first output port by a hydraulic line;
wherein the optional fourth actuator is coupled to the second output port by an optional hydraulic line;
wherein the second selection switch in its flying mode position connects its input port to the its first output port; and
wherein the second selection switch in its road riding mode position connects its input port to its second output port.

16. The hybrid fly/drive vehicle according to claim 13, wherein the first and second selection switches are coupled switches or are part of one common switch unit, to ensure that they are always switched simultaneously.

17. The hybrid fly/drive vehicle according to claim 13, wherein the second road riding mode function is absent, and wherein the fourth actuator is absent.

18. The hybrid fly/drive vehicle according to claim 17, wherein the second selection switch is replaced by a fixed hydraulic connection between the second hydraulic control unit and the third actuator.

19. A hybrid fly/drive vehicle, capable of being converted between a flying mode in which it is capable of and certified for flying in air and a road riding mode in which it is capable of and certified for driving on a road in normal traffic, the vehicle comprising:
a first foot pedal with associated first hydraulic control unit;
a second foot pedal with associated second hydraulic control unit;
a loop of hydraulic lines between the first hydraulic control unit and the second hydraulic control unit;
an arrangement of at least one hydraulic rudder control actuator included in the loop, configured to control to position of at least one rudder as controlled by displacement of the foot pedals; and
at least one hydraulic selection switch included in the loop between one of the hydraulic control units and the arrangement of at least one hydraulic rudder control actuator, the hydraulic selection switch having a flying mode position and a road riding mode position, wherein:
in its flying mode position, the at least one hydraulic selection switch hydraulically connects the one of the hydraulic control units to the arrangement of at least one hydraulic rudder control actuator; and
in its road riding mode position, the at least one hydraulic selection switch hydraulically seals off the arrangement of at least one hydraulic rudder control actuator and hydraulically connects the one of the hydraulic control units to an associated road riding function actuator.

20. The hybrid fly/drive vehicle according to claim 19, wherein the associated road riding function actuator is an accelerator actuator.

21. The hybrid fly/drive vehicle according to claim 19, wherein the associated road riding function actuator is a clutch actuator.

22. A vehicle, capable of and certified for flying in air and comprising:
a landing gear including lefthand and righhand wheels, each wheel being provided with respective brakes;
at least one rudder for yaw control;
a set of pedals for controlling rudder position and for actuating the brakes; and
a pedal force sensing and control system capable of sensing pedal force and, depending on pedal force, selectively operating in:
a first operative condition when each pedal force is below a respective threshold value, in which case the pedals exclusively control the at least one rudder for yaw control;
a second operative condition when each pedal force is above the respective threshold value, in which case both brakes are actuated to the same extent; and
a third operative condition when one pedal force is above the respective threshold value while the other pedal force is below the respective threshold value, in which case only the one brake corresponding to the one pedal is actuated.

23. The vehicle according to claim 22, wherein the third operative condition can be achieved only when the at least one rudder has reached an extreme position.

24. The vehicle according to claim 22, further comprising:
a lefthand foot pedal with associated lefthand hydraulic control unit;
a righthand foot pedal with associated righthand hydraulic control unit;
a loop of hydraulic lines between the lefthand hydraulic control unit and the righthand hydraulic control unit;
an arrangement of at least one hydraulic rudder control actuator included in the loop, configured to control to position of at least one rudder as controlled by displacement of the foot pedals;
a first hydraulic pressure sensor and control unit having an input connected to the lefthand hydraulic control unit and having an output connected to the lefthand brake; and
a second hydraulic pressure sensor and control unit having an input connected to the righthand hydraulic control unit and having an output connected to the righthand brake;
wherein each hydraulic pressure sensor and control unit is configured to apply pressure at its respective output when the pressure at its respective input is above a threshold pressure.

25. The vehicle according to claim 24, wherein each hydraulic pressure sensor and control unit comprises a separation piston arranged sealingly in a chamber between its respective output and its respective input, a stop arranged in the chamber, and a bias member exerting a bias force on the separation piston towards the stop.

26. The vehicle according to claim 22, capable of being converted between a flying mode in which it is capable of and certified for flying in air and a road riding mode in which it is capable of and certified for driving on a road in normal traffic.

27. The vehicle according to claim 26 further comprising:
a third foot pedal provided with a third hydraulic control unit;
a third hydraulic brake line for connecting the third hydraulic control unit to the righthand brake member; and
a fourth hydraulic brake line for connecting the third hydraulic control unit to the lefthand brake member.

28. The vehicle according to claim 27, wherein each hydraulic pressure sensor and control unit has a non-biased input port connected to the third or fourth hydraulic brake line, respectively; and
wherein each hydraulic pressure sensor and control unit is configured, if the pressure at its biased input is below the respective threshold value, to connect the non-biased input port to the output, and if the pressure at its biased input is above the respective threshold value, to close the non-biased input port.

29. The vehicle according to claim 27, wherein the third and fourth hydraulic brake lines have at least one line portion in common.

30. The vehicle according to claim 27 further comprising a central wheel provided with a hydraulically controlled third brake member hydraulically coupled to the third hydraulic control unit.

31. The vehicle according to claim 27, wherein the third foot pedal is positioned in between the righthand foot pedal and the lefthand foot pedal.

32.-33. (canceled)

34. A hybrid fly/drive vehicle, capable of being converted between a flying mode in which it is capable of and certified for flying in air and a road riding mode in which it is capable of and certified for driving on a road in normal traffic, comprising an engine and an arrangement to allow the engine to be pedal-controlled in road riding mode and lever-controlled in flying mode, and further comprising pedals for throttle or clutch actuation in road riding mode and for rudder control in flying mode, which pedals also actuate the brakes in flying mode.
